(19) United States
(12) Patent Application Publication
(10) Pub. No.: US 2026/0343431 A1
(43) Pub. Date: Oct. 29, 2026

(54) POWER HEADROOM REPORT CONFIGURATION FOR USER EQUIPMENT WITH FULL-DUPLEX CAPABILITIES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed IBRAHIM, San Diego, CA (US)

(21) Appl. No.: 19/193,550

(22) Filed: Apr. 29, 2025

(51) Int. Cl. H04W 52/36; H04L 5/14

(52) U.S. Cl. CPC H04W 52/365; H04L 5/14

(57) ABSTRACT

Various aspects of the present disclosure generally relate to wireless communication. In some aspects, a user equipment (UE) may receive, from a network node, a power headroom report (PHR) configuration indicating one or more PHR parameters for operation in a full-duplex mode in unpaired spectrum. The UE may transmit, to the network node, a PHR in accordance with the PHR configuration. Numerous other aspects are described.

### FIELD OF THE DISCLOSURE

Aspects of the present disclosure generally relate to wireless communication and specifically relate to techniques, apparatuses, and methods associated with a power headroom report configuration for a user equipment with full-duplex capabilities.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In a wireless network, a user equipment (UE) may transmit a power headroom report (PHR) to a network node to report the power headroom at the UE. The PHR may indicate a difference between a nominal UE maximum transmission power and an estimated power for uplink transmission. For example, to calculate the power headroom, the UE may subtract a power level associated with one or more physical uplink shared channel (PUSCH) transmissions from a (nominal) maximum transmission power for the UE. When the power headroom has a positive value, the power headroom value in the PHR indicates that the UE has available space under the maximum transmission power (e.g., can transmit more uplink data or transmit using a higher transmit power). On the other hand, when the power headroom has a negative value, the power headroom value indicates that the estimated power for uplink transmission at a power level that exceeds the maximum transmission power for the UE. In this way, the network node can use the information carried in the PHR to make decisions related to resource allocation and power control to maintain balance and avoid interference issues within the wireless network (e.g., depending on whether the UE has a sufficient power margin to increase transmission power or has exceeded a power budget and needs to decrease transmission power to mitigate interference or satisfy emission requirements).

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, from a network node, a power headroom report (PHR) configuration indicating one or more PHR parameters for operation in a full-duplex mode in unpaired spectrum. The method may include transmitting, to the network node, a PHR in accordance with the PHR configuration.

Some aspects described herein relate to a method of wireless communication performed by a network node. The method may include transmitting, to a UE, a PHR configuration indicating one or more PHR parameters for operation in a full-duplex mode in unpaired spectrum. The method may include receiving, from the UE, a PHR in accordance with the PHR configuration.

Some aspects described herein relate to a UE. The UE may include a processing system. The processing system may include one or more processors and one or more code-storing memories coupled with the one or more processors. The processing system may be configured to cause the UE to receive, from a network node, a PHR configuration indicating one or more PHR parameters for operation in a full-duplex mode in unpaired spectrum. The processing system may be configured to cause the UE to transmit, to the network node, a PHR in accordance with the PHR configuration.

Some aspects described herein relate to a network node. The network node may include a processing system. The processing system may include one or more processors and one or more code-storing memories coupled with the one or more processors. The processing system may be configured to cause the network node to transmit, to a UE, a PHR configuration indicating one or more PHR parameters for operation in a full-duplex mode in unpaired spectrum. The processing system may be configured to cause the network node to receive, from the UE, a PHR in accordance with the PHR configuration.

Some aspects described herein relate to a non-transitory computer-readable medium that stores a set of instructions for wireless communication by a UE. The set of instructions, when executed by one or more processors of the UE, may cause the UE to receive, from a network node, a PHR configuration indicating one or more PHR parameters for operation in a full-duplex mode in unpaired spectrum. The set of instructions, when executed by one or more processors of the UE, may cause the UE to transmit, to the network node, a PHR in accordance with the PHR configuration.

Some aspects described herein relate to a non-transitory computer-readable medium that stores a set of instructions for wireless communication by a network node. The set of instructions, when executed by one or more processors of the network node, may cause the network node to transmit, to a UE, a PHR configuration indicating one or more PHR parameters for operation in a full-duplex mode in unpaired spectrum. The set of instructions, when executed by one or more processors of the network node, may cause the network node to receive, from the UE, a PHR in accordance with the PHR configuration.

Some aspects described herein relate to an apparatus for wireless communication. The apparatus may include means for receiving, from a network node, a PHR configuration indicating one or more PHR parameters for operation in a full-duplex mode in unpaired spectrum. The apparatus may include means for transmitting, to the network node, a PHR in accordance with the PHR configuration.

Some aspects described herein relate to an apparatus for wireless communication. The apparatus may include means for transmitting, to a UE, a PHR configuration indicating one or more PHR parameters for operation in a full-duplex mode in unpaired spectrum. The apparatus may include means for receiving, from the UE, a PHR in accordance with the PHR configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating examples of full-duplex communication in a wireless network.

FIG. 3 is a diagram illustrating examples of full-duplex deployment scenarios.

FIG. 4 is a diagram illustrating examples of different duplexing modes.

FIG. 5 is a diagram illustrating an example associated with a power headroom report (PHR) configuration and examples associated with conditions that may impact an available transmission power at a user equipment (UE) with full-duplex capabilities.

FIG. 6 is a diagram illustrating examples associated with a PHR configuration for a UE with full-duplex capabilities.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

As described herein, a user equipment (UE) may transmit a power headroom report (PHR) to a network node to indicate a difference between a nominal UE maximum transmission power and an estimated power for uplink transmission, or to indicate that an estimated power for uplink transmission at a power level that exceeds a maximum transmission power for the UE. In general, a UE may be configured to transmit a PHR when one or more PHR trigger events occur. For example, the network node may provide a PHR configuration to the UE, where the PHR configuration may include parameters such as a PHR periodic timer, a PHR prohibit timer, or a threshold related to a change in a transmit power factor. Accordingly, a PHR transmission may be triggered at periodic intervals (e.g., each time that the PHR periodic timer expires) or when one or more conditions are satisfied. For example, the one or more conditions may include a change to a path loss satisfying (e.g., equaling or exceeding) the configured threshold, or a power backoff due to power management satisfying the configured threshold, provided that the PHR prohibit timer has expired. In particular, the UE may start the PHR prohibit timer and/or the PHR periodic timer when a PHR is transmitted, and the UE may be prohibited from transmitting a conditional PHR (e.g., a PHR triggered by one or more conditions, such as a change to a path loss or power backoff) until the PHR prohibit timer expires. In the event that the UE does not transmit a conditional PHR after the PHR prohibit timer has expired, the UE may be required to transmit a PHR after the PHR periodic timer expires (e.g., unless infinity is the configured value for the PHR periodic timer, which effectively disables periodic PHR transmission). In this way, the PHR prohibit timer and the PHR periodic timer may interact to ensure that the UE does not transmit many PHRs in a short time period (e.g., due to frequent changes to the path loss or power backoff) and to ensure that the network node has updated information regarding the available transmit power at the UE.

The one or more conditions, triggering events, timer values, or other parameters in a PHR configuration are generally designed for UEs that operate in a half-duplex mode (e.g., only transmitting on an uplink or receiving on a downlink at any given time) in unpaired spectrum such as a time division duplexing (TDD) band, or in paired spectrum or a frequency division duplexing (FDD) band where uplink and downlink frequencies have a sufficient separation to prevent interference between simultaneous downlink and uplink communication. However, in some cases, a UE may support a full-duplexing mode in unpaired spectrum, such as a sub-band full-duplex (SBFD) mode or an in-band full-duplex (IBFD) mode. In the SBFD mode, a UE may simultaneously transmit on an uplink and receive on a downlink using uplink frequency resources and downlink frequency resources that are in the same frequency band and separated by a guard band. In the IBFD mode, a UE may simultaneously transmit on an uplink and receive on a downlink using uplink frequency resources and downlink frequency resources that fully or partially overlap.

Accordingly, because the SBFD and IBFD modes operate in unpaired spectrum, where the uplink and downlink frequency resources overlap or have a small separation in a frequency domain, a UE may operate in the SBFD or IBFD mode opportunistically, depending on dynamic interference conditions. For example, operation in the SBFD or IBFD mode may be conditioned on uplink transmission not causing self-interference with downlink reception. Self-interference may occur when there is insufficient separation between uplink and downlink beams, because a transmitted signal leaks into a receive port, or due to clutter effects or clutter echo when an object in a surrounding environment reflects a transmitted signal back to a receive port. Additionally, or alternatively, operation in the SBFD or IBFD mode may be conditioned on inter-cell interference (ICI), where uplink transmission by a full-duplex UE interferes with reception capabilities at a network node or a UE in a neighboring cell, or where transmission by a network node or UE in a neighboring cell interferes with reception capabilities at the full-duplex UE. As a result, because operation in the SBFD or IBFD mode is conditional depending on several factors, including an uplink transmission configuration (e.g., a transmit power, uplink beam, or uplink resource allocation), a downlink transmission configuration (e.g., a frequency gap, downlink beam, or rank), and environmental effects (e.g., clutter echo or inter-cell interference), the transmission power that is available at a UE with SBFD or IBFD capabilities is more dynamic and related to different variables relative to a UE operating in a legacy half-duplex or FDD mode. However, as described above, the parameters and conditions that define PHR trigger events do not accommodate the dynamic conditions that impact SBFD and IBFD operation, such as self-interference, inter-cell interference, a desense level, a change to a maximum transmission power, or interference cancellation efficiency.

Various aspects relate generally to a PHR configuration for a UE having full-duplex capabilities, such as an SBFD capability or an IBFD capability. Some aspects more specifically relate to a UE indicating an SBFD capability or IBFD capability to a network node, such that the network node may provide the UE with a PHR configuration that includes one or more PHR parameters related to the SBFD or IBFD capability. For example, in some aspects, the PHR parameters may include a PHR prohibit timer specific to the SBFD or IBFD mode, such that no (subsequent) PHR is triggered before the SBFD-specific or IBFD-specific PHR prohibit timer expires regardless of any change to conditions impacting operation in the full-duplex mode. In some aspects, the PHR parameters may additionally include one or more thresholds that are specific to parameters related to the SBFD or IBFD mode, such as self-interference, inter-cell interference, a desense level, or a maximum transmission power. Accordingly, after the PHR prohibit timer associated with the full-duplex mode has expired, a PHR may be conditionally triggered when a change to the self-interference, inter-cell interference, desense level, or maximum transmission power satisfies the applicable threshold(s). In some aspects, because the UE may operate in the SBFD or IBFD mode opportunistically, and otherwise operate in the legacy half-duplex or FDD mode, the PHR configuration may additionally indicate a legacy PHR prohibit timer and a legacy threshold related to a change to a transmit power factor, where the PHR prohibit timer for the SBFD/IBFD mode and the legacy PHR prohibit timer may have the same value or different values (e.g., such that PHR trigger events associated with the SBFD/IBFD mode and the legacy mode may become valid at different times).

Furthermore, because the UE can opportunistically switch between operating in the SBFD/IBFD mode and a legacy mode, some aspects described herein relate to conditions for transmitting a PHR or other information to a network node to indicate a change to the full-duplexing capability associated with the UE (e.g., losing or regaining capabilities to operate in the SBFD/IBFD mode).

Particular aspects of the subject matter described in this disclosure can be implemented to realize one or more of the following potential advantages. In some examples, by providing a UE with a PHR configuration that includes one or more PHR parameters associated with an SBFD, IBFD, or other full-duplex capability associated with the UE, the described techniques can provide PHR trigger events or PHR trigger conditions that are responsive to dynamic conditions that impact the transmission power that may be available to the UE or the duplexing mode in which the UE operates, among other examples. For example, a change to a self-interference level, an inter-cell interference level, a densense level, or a maximum transmission power may impact the transmission available to the UE in the SBFD or IBFD mode, or the capability that the UE has to operate in the SBFD mode. Accordingly, by providing configuring PHR trigger events or PHR trigger conditions and associated PHR configuration parameters, the described techniques may enable a network node to appropriately modify an uplink configuration, a downlink configuration, or other suitable configuration for the UE when there is a change to one or more conditions related to the full-duplex capability. In this way, the network node can make scheduling and configuration decisions to improve performance or mitigate interference at the UE, other UEs in a serving cell, or network nodes or UEs operating in one or more neighboring cells.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD or IBFD), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

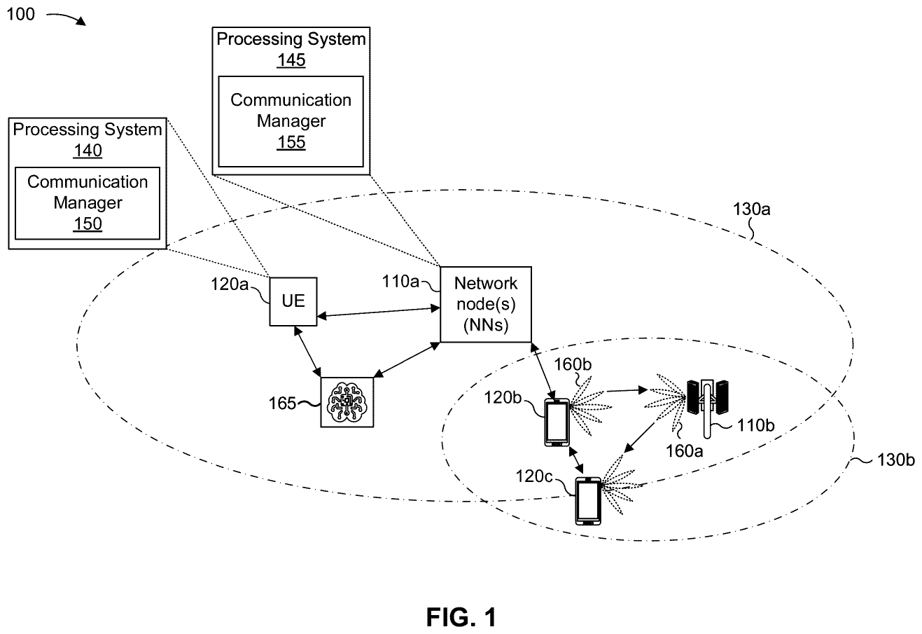

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collect measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD or IBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve FDD, in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive, from the network node, a PHR configuration indicating one or more PHR parameters for operation in a full-duplex mode in unpaired spectrum; and transmit, to the network node 110, a PHR in accordance with the PHR configuration. Additionally, or alternatively, the communication manager 150 may perform one or more other operations described herein.

In some aspects, the network node 110 may include a communication manager 155. As described in more detail elsewhere herein, the communication manager 155 may transmit, to the UE 120, a PHR configuration indicating one or more PHR parameters for operation in a full-duplex mode in unpaired spectrum; and receive, from the UE 120, a PHR in accordance with the PHR configuration. Additionally, or alternatively, the communication manager 155 may perform one or more other operations described herein.

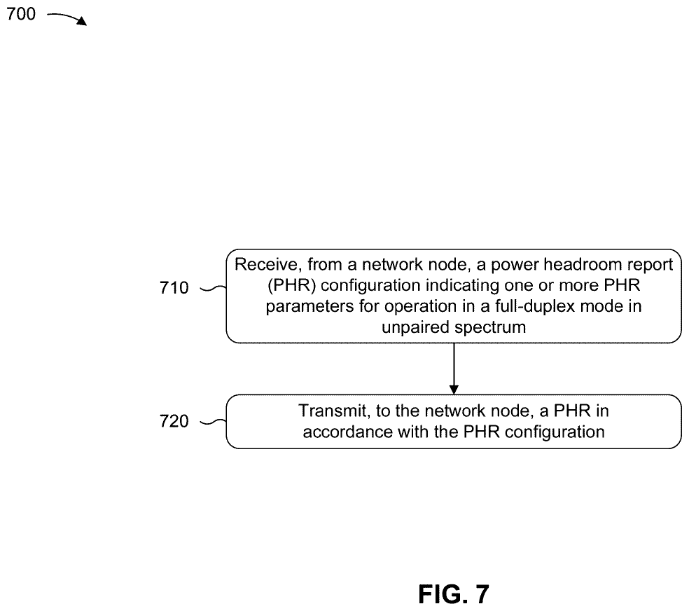

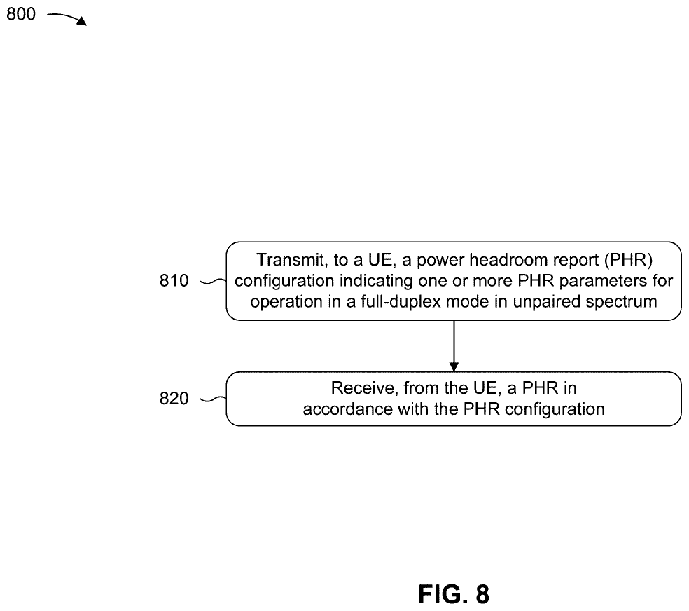

The network node 110, the processing system 145 of the network node 110, the UE 120, the processing system 140 of the UE 120, or any other component(s) of FIG. 1 may implement one or more techniques or perform one or more operations associated with a PHR configuration for a UE 120 with full-duplex capabilities, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

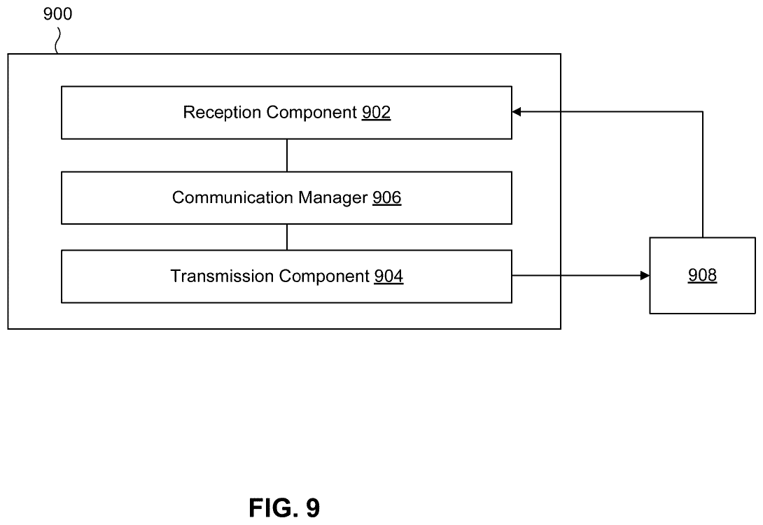

In some aspects, the UE 120 includes means for receiving, from a network node 110, a PHR configuration indicating one or more PHR parameters for operation in a full-duplex mode in unpaired spectrum; or means for transmitting, to the network node 110, a PHR in accordance with the PHR configuration. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

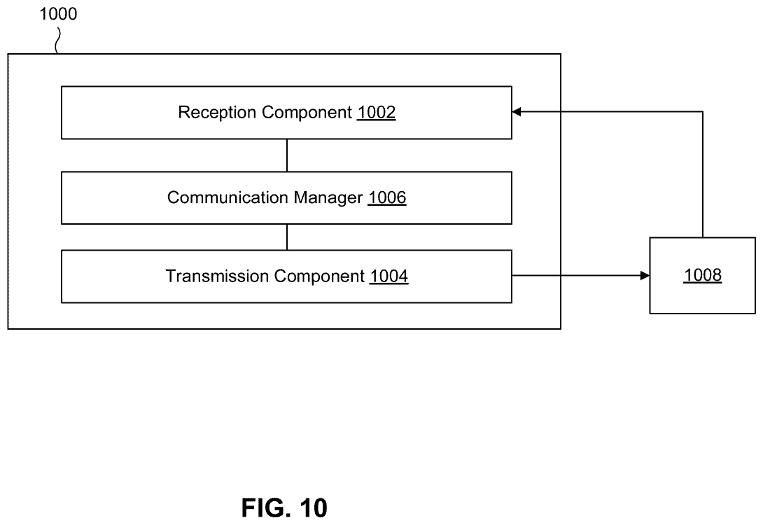

In some aspects, the network node 110 includes means for transmitting, to a UE 120, a PHR configuration indicating one or more PHR parameters for operation in a full-duplex mode in unpaired spectrum; or means for receiving, from the UE 120, a PHR in accordance with the PHR configuration. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

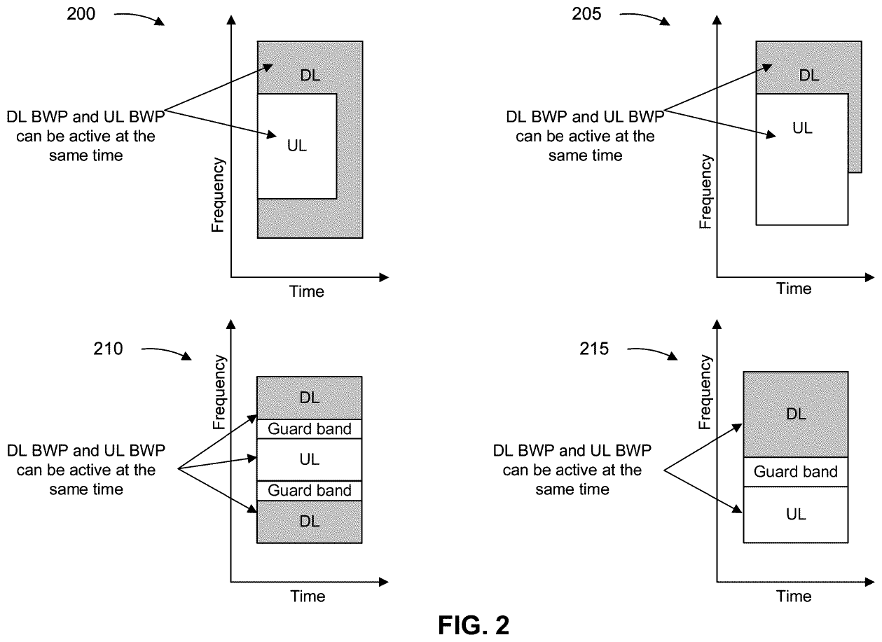

FIG. 2 is a diagram illustrating examples 200, 205, 210, and 215 of full-duplex communication in a wireless network. As described herein, “full-duplex communication” refers to simultaneous uplink and downlink communication in a wireless network, which may be a capability of a UE 120, a network node 110, or another suitable device (e.g., a mobile termination (MT) component or a forwarding (FWD) component of a network-controlled repeater (NCR)). For example, a UE 120 operating in a full-duplex mode may transmit an uplink communication and receive a downlink communication at the same time (e.g., in the same slot or the same symbol), and a network node 110 operating in a full-duplex mode may receive an uplink communication and transmit a downlink communication at the same time. “Half-duplex communication” in a wireless network refers to unidirectional communications (e.g., only downlink communication or only uplink communication) at a given time (e.g., a device only transmits or only receives in a given slot or a given symbol). In some cases, one or more nodes in a wireless network may support full-duplex communication and half-duplex communication, and other nodes may support half-duplex communication only. For example, in some aspects, a network node 110 may support full-duplex and half-duplex communication, and one or more UEs 120 may support half-duplex communication only.

As shown in FIG. 2, examples 200 and 205 show IBFD communication. In a scenario where a network node 110 supports IBFD and a UE 120 supports half-duplex communication only, the network node 110 may receive an uplink communication from a first UE 120 and may transmit a downlink communication to a second UE 120 on the same time and frequency resources. As shown in example 200, in a first example of IBFD, the time and frequency resources for uplink communication may fully overlap with the time and frequency resources for downlink communication (e.g., all time and frequency resources allocated to uplink communication are also available for downlink communication). As shown in example 205, in a second example of IBFD, the time and frequency resources for uplink communication may partially overlap with the time and frequency resources for downlink communication (e.g., some time and frequency resources are reserved for uplink communication only).

As further shown in FIG. 2, examples 210 and 215 show SBFD communication, which may also be referred to as “sub-band frequency division duplex (SBFDD),” “flexible duplex,” or “FDD in unpaired spectrum.” In some aspects, an SBFD communication mode may be supported by a network node 110 only, by a network node 110 and a UE 120, by a UE 120 only, or any suitable combination thereof. In the SBFD communication mode, a node operating in accordance with an SBFD configuration may simultaneously transmit and receive different communications at the same time, but on different frequency resources in the same component carrier. For example, a network node 110 operating in an SBFD mode may simultaneously receive an uplink communication from a first UE 120 in an uplink sub-band and transmit a downlink communication to a second UE 120 in a downlink sub-band, where the uplink sub-band and the downlink sub-band may occupy different frequency resources. Similarly, a UE 120 operating in an SBFD mode may simultaneously transmit an uplink communication to a network node 110 in an uplink sub-band and receive a downlink communication from the network node 110 in a downlink sub-band. For example, the uplink sub-band and the downlink sub-band may be sub-bands of a frequency band, such as a TDD band, or a component carrier of a frequency band. In this case, the frequency resources used for downlink communication may be separated from the frequency resources used for uplink communication, in the frequency domain, by one or more guard bands. For example, as shown in example 210, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Alternatively, as shown in example 215, SBFD communication may be configured in a D+U pattern, where a component carrier bandwidth or frequency band is partitioned into a downlink sub-band and an uplink sub-band that are separated by a guard band.

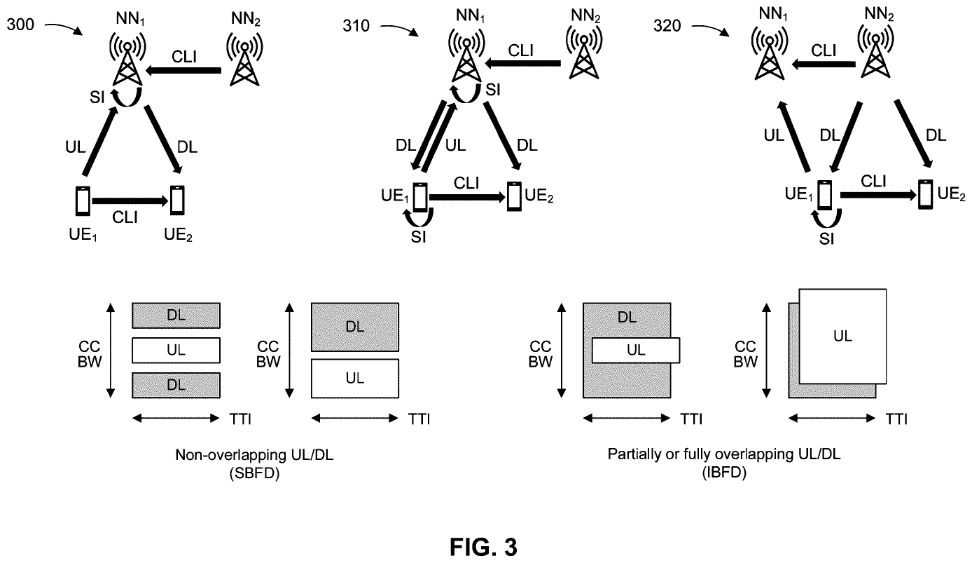

FIG. 3 is a diagram illustrating examples 300, 310, 320 of full-duplex deployment scenarios. As shown in FIG. 3, examples 300, 310, 320 include one or more UEs in communication with one or more network nodes in a wireless network that supports full-duplex communication. In general, as described herein, utilizing a full-duplexing communication mode may provide reduced latency by allowing a downlink transmission to occur in an uplink-only symbol or slot or by allowing an uplink transmission to occur in a downlink-only or flexible symbol or slot. In addition, full-duplex communication may increase an uplink duty cycle, which may improve uplink coverage, may enhance spectral efficiency or throughput per cell or per UE, may increase system capacity, may enable more efficient resource utilization by simultaneously utilizing time and frequency resources for downlink and uplink communication, or may enable flexible and dynamic uplink and downlink resource adaptation according to uplink or downlink traffic patterns. However, as described in further detail herein, full-duplexing communication modes may be associated with dynamic interference conditions.

For example, as shown in FIG. 3, example 300 includes a first UE (shown as UE₁) and a second UE (shown as UE₂) in communication with a first network node (shown as NN₁) operating in a full-duplexing mode, with the first UE and the second UE operating in a half-duplexing mode. For example, as shown in FIG. 3, the first UE may transmit one or more uplink transmissions to the first network node, and the second UE may concurrently receive one or more downlink transmissions from the first network node. Accordingly, in example 300, the first network node is operating in a full-duplexing mode, and the first UE and the second UE are each operating in a half-duplexing mode. As shown by example 300, there may be various forms of interference that may degrade downlink reception performance at one or more UEs or uplink reception performance at the first network node operating in the full-duplexing mode. For example, as shown, the first network node may experience cross-link interference (CLI) caused by downlink transmissions from a second network node (shown as NN₂) that may be located in an adjacent or nearby cell. Furthermore, as shown, the uplink transmission from the first UE to the first network node may cause CLI at the second UE (e.g., CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port or when an object in a surrounding environment reflects a transmitted signal back to a receive port (e.g., causing a clutter echo effect), thus interfering with reception of a desired signal at the receive port. In general, the full-duplexing mode used by the first network node in example 300 may be an SBFD mode, where a component carrier bandwidth is divided into an uplink sub-band and one or more downlink sub-bands that are separated by one or more guard bands. Additionally, or alternatively, the full-duplexing mode may be an IBFD mode, where uplink and downlink resources fully or partially overlap.

As further shown in FIG. 3, in example 310, a first UE may communicate with a first network node in a full-duplexing mode. For example, in example 310, the first UE may receive one or more downlink transmissions from the first network node, and the first UE may concurrently transmit one or more uplink transmissions to the first network node. Accordingly, in example 310, the first network node and the first UE are both operating in a full-duplexing (e.g., SBFD or IBFD) mode. Furthermore, as shown, the first network node may be communicating with a second UE operating in a half-duplexing mode. As shown by example 310, the first UE may experience self-interference, where the uplink transmission to the first network node interferes with reception of the downlink transmission from the first network node, and the first UE may cause CLI at the second UE, where the uplink transmission to the first network node interferes with downlink reception at the second UE. Additionally, in example 310, the first network node may experience CLI caused by one or more downlink transmissions from a second network node interfering with reception of the uplink transmission from the first UE, and the first network node may experience self-interference, where downlink transmission(s) to the first UE or the second UE interferes with reception of the uplink transmission from the first UE. In example 310, the full-duplex communication may be performed in an SBFD mode or an IBFD mode.

As further shown in FIG. 3, in example 320, a first UE may communicate with a first network node and a second network node in a full-duplexing mode (e.g., a multi-TRP mode). For example, in example 320, the first UE may transmit one or more uplink transmissions to the first network node (e.g., a first TRP), and the first UE may concurrently receive one or more downlink transmissions from the second network node (e.g., a second TRP). Accordingly, in example 320, the first UE is operating in a full-duplexing mode, and the first and second network nodes are both operating in a half-duplexing mode. As shown by example 320, the first UE may experience self-interference, where the uplink transmission to the first network node interferes with reception of the downlink transmission from the second network node. Furthermore, the uplink transmission by the first UE may cause CLI at a second UE receiving a downlink transmission from the second network node. Furthermore, as shown, the downlink transmission by the second network node may cause CLI that interferes with uplink reception at the first network node. In example 320, the full-duplex communication may be performed in an SBFD mode or an IBFD mode.

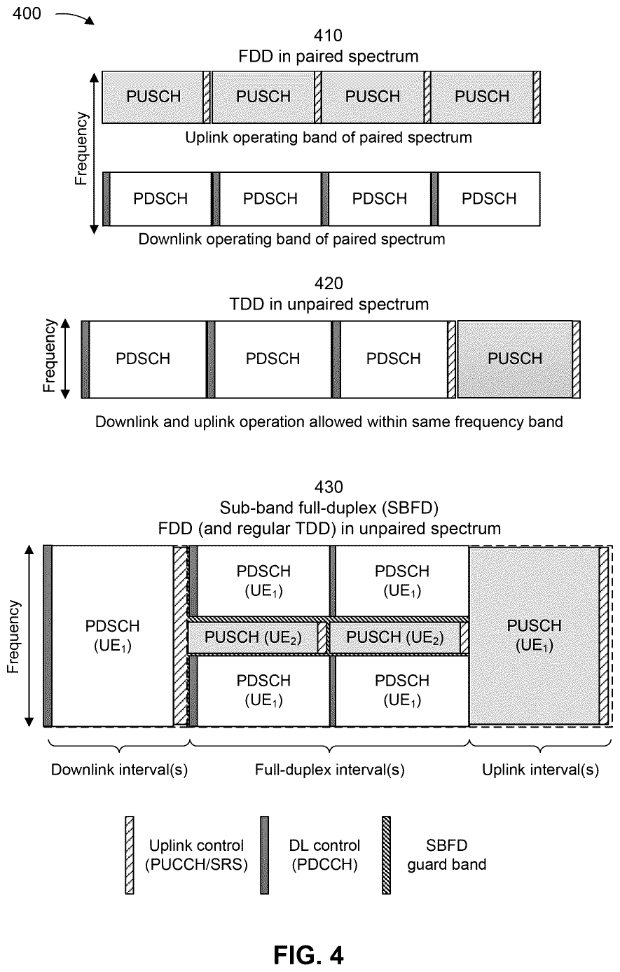

FIG. 4 is a diagram illustrating examples 400 of different duplexing modes. For example, as described in further detail herein, FIG. 4 illustrates an example 410 of an FDD mode that may be used in paired spectrum, an example 420 of a TDD mode that may be used in unpaired spectrum, and an example 430 of an SBFD mode that may be used in unpaired spectrum.

In some aspects, a wireless communication standard or governing body may generally specify one or more duplexing modes in which a wireless spectrum is to be used. For example, 3GPP may specify how wireless spectrum is to be used for a RAT or air interface. As an example, a specification may indicate whether a band is to be used as paired spectrum in an FDD mode, as unpaired spectrum in a TDD mode, or another duplexing mode (e.g., SBFD).

For example, as shown by example 410, paired spectrum in the FDD mode may use a first frequency region (or band) for uplink communication and a second frequency region (or band) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full-duplex capabilities may perform concurrent transmit and receive operations using different operating bands allocated to downlink and uplink communication, respectively. For example, paired bands in NR include NR operating bands n1, n2, n3, n5, n7, n8, n12, n20, n25, and n28, as specified by 3GPP Technical Specification (TS) 38.101-1.

Alternatively, as shown by example 420, unpaired spectrum in the TDD mode may allow downlink and uplink operation within a single frequency region (e.g., a single operating band). For example, when operating in TDD mode in unpaired spectrum, downlink communication and uplink communication may occur in the same frequency resources. Some deployments may use TDD or a legacy half-duplexing mode in the unpaired band, whereby some transmission time intervals (TTIs) (e.g., frames, slots, or symbols) are used for downlink communication only and other TTIs are used for uplink communication only. In this case, substantially the entire bandwidth of a component carrier may be used for downlink communication or uplink communication, depending on whether the communication is performed in a downlink-only interval, an uplink-only interval, or a flexible interval (in which either downlink or uplink communication can be scheduled). Examples of unpaired bands include NR operating bands n40, n41, and n50, as specified by 3GPP TS 38.101-1. In some cases, however, using TDD in unpaired spectrum may be inefficient. For example, uplink transmit power may be limited, meaning that UEs may be incapable of transmitting with enough power to efficiently utilize the full component carrier bandwidth in an uplink interval. This may be particularly problematic in large cells at the cell edge. Furthermore, using TDD may introduce latency relative to a full-duplexing scheme in which uplink communications and downlink communications can be performed in the same time interval, because TDD restricts usage of a given TTI to uplink-only or downlink-only. Furthermore, using TDD may reduce spectral efficiency or reduce throughput by restricting usage of a given TTI to uplink-only or downlink-only.

Accordingly, as shown by example 430, an unpaired band may be configured in a full-duplexing mode to enable concurrent transmit and receive operations in unpaired spectrum (e.g., a TDD band). For example, in FIG. 4, example 430 depicts an SBFD mode, which may be referred to as full-duplexing in a frequency division multiplexing (FDM) mode or other suitable terminology, in order to enable TDD operation or FDD operation in unpaired spectrum. For example, as shown in FIG. 4, an unpaired band configured in the SBFD mode may associate one or more TTIs with downlink communication only (e.g., “D” slots), one or more TTIs for uplink communication only (e.g., “U” slots), and one or more TTIs for both downlink communication and uplink communication (e.g., “D+U” slots). Each TTI may be associated with a control region, illustrated as a portion of a time interval with a diagonal fill for uplink control (e.g., a PUCCH) or a darker-shaded fill for downlink control (e.g., a PDCCH). Additionally, or alternatively, each TTI may be associated with a data region, which is shown as a PDSCH for downlink frequency regions or a PUSCH for uplink frequency regions.

In some aspects, an unpaired band configured in the SBFD mode may include one or more full-duplex time intervals (e.g., frames, subframes, slots, or symbols, among other examples) that are associated with an FDD configuration. For example, as shown in FIG. 4, the FDD configuration associated with a full-duplex time interval may indicate one or more downlink frequency regions (or sub-bands) and one or more uplink frequency regions (or sub-bands) that are separated by a guard band. For example, as shown by example 430, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Alternatively, SBFD communication may be configured in a D+U pattern (not explicitly shown in FIG. 4), where a component carrier bandwidth or frequency band, or a portion thereof, such as a bandwidth part, is partitioned into a downlink sub-band and an uplink sub-band separated by a guard band.

Accordingly, an FDD configuration may divide an unpaired frequency band (e.g., one or more component carriers of an unpaired band) into uplink frequency regions, downlink frequency regions, or other regions (e.g., guard bands, control regions, or the like), which may enable a network node or a UE with full-duplex capabilities to perform simultaneous transmit and receive operations during one or more full-duplex time intervals in which frequency resources are divided into downlink and uplink sub-bands with a guard band separation. Different from paired spectrum in FDD mode, the guard band is generally insufficient to prevent self-interference caused by an uplink transmission with respect to a downlink reception.

For example, in a given full-duplex time interval, a half-duplexing UE may either transmit using the uplink frequency region or receive in the downlink frequency region (e.g., a UE communicating in a half-duplexing mode may only receive in a downlink frequency region or transmit in an uplink frequency region during the full-duplex time intervals). Alternatively, a full-duplexing UE may transmit using the uplink frequency region and receive in the downlink frequency region (e.g., where UE₁ and UE₂ in FIG. 4 are the same UE). Additionally, or alternatively, a full-duplexing network node may transmit a downlink communication to a first UE within the downlink frequency regions(s) and simultaneously receive an uplink communication from a second UE in the uplink frequency region(s). In some aspects, the FDD configuration may identify BWP configurations corresponding to the uplink frequency regions and the downlink frequency regions. For example, a respective BWP may be configured for each uplink and downlink frequency region.

Additionally, or alternatively, full-duplexing may be enabled in unpaired spectrum in an IBFD mode, which may be referred to herein as full-duplexing in a spatial division multiplexing (SDM) mode. For example, in an IBFD mode or a full-duplexing in SDM mode, uplink communication may occur on time and frequency resources that fully overlap time and frequency resources allocated to downlink communication (e.g., all of the time and frequency resources available for uplink communication are also available for downlink communication). Alternatively, uplink communication may occur on time and frequency resources that partially overlap with time and frequency resources available for downlink communication (e.g., some time and frequency resources available for uplink communication are also available for downlink communication and some time and frequency resources available for uplink communication are uplink-only). Alternatively, downlink communication may occur on time and frequency resources that partially overlap with time and frequency resources available for uplink communication (e.g., some time and frequency resources available for downlink communication are also available for uplink communication and some time and frequency resources available for downlink communication are downlink-only). In general, in the SBFD mode or the IBFD mode, full-duplex communication may be conditional on sufficient beam separation between an uplink beam and a downlink beam (e.g., uplink transmission may be from one antenna panel and downlink reception may be in another antenna panel) in order to minimize self-interference that may occur when a transmitted signal leaks into a receive port or when an object in a surrounding environment reflects a transmitted signal back to a receive port (e.g., causing a clutter echo effect).

In some cases, as described herein, one or more frequency regions that support SBFD communication may be configured to dynamically switch between operating in a TDD mode (e.g., a half-duplexing mode in which each slot or symbol is uplink-only or downlink-only, also referred to as duplexing mode 1, a legacy half-duplexing mode, or the like) and one or more SBFD modes. For example, in a scenario where only a network node supports SBFD operation, one or more downlink or flexible slots or symbols can be semi-statically or dynamically configured in a first SBFD mode (referred to as duplexing mode 2, a network node SBFD mode, or the like) in which the network node simultaneously transmits a downlink communication to a first UE in one or more downlink sub-bands and receives an uplink communication from a second UE in an uplink sub-band, and any other slots or symbols may be configured in the legacy half-duplexing (e.g., downlink-only or uplink-only). Furthermore, in cases where a UE supports SBFD operation, one or more slots or symbols can be configured in a second SBFD mode (referred to as duplexing mode 3, or a UE and network node SBFD mode) in which a network node operating in SBFD mode communicates with a UE operating in SBFD mode or in a third SBFD mode (referred to as duplexing mode 4, a UE SBFD mode, or the like) in which a UE operating in SBFD mode communicates with a first TRP operating in a half-duplexing mode and a second TRP operating in a half-duplexing mode. In general, the second and third SBFD modes may be similar from a UE perspective, and may be transparent to an SBFD-capable UE in cases where two TRPs or cells are associated with the same cell or DU. Furthermore, aspects described herein that relate to full-duplex operation may apply to SBFD or IBFD operation.

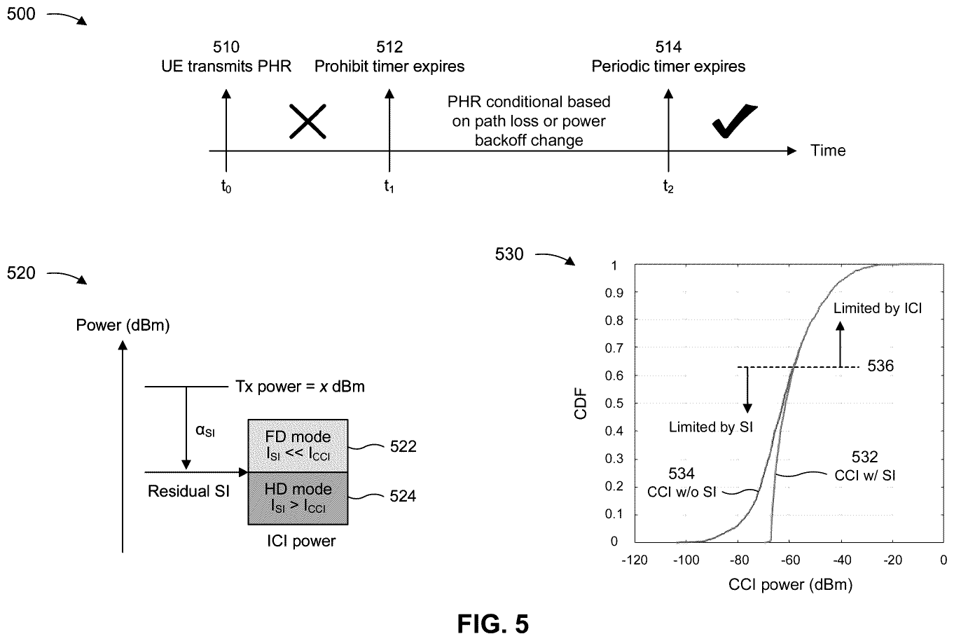

FIG. 5 is a diagram illustrating an example 500 associated with a PHR configuration and examples 520 and 530 associated with conditions that may impact an available transmission power at a UE with full-duplex capabilities.

In example 500, a network node 110 may transmit, and a UE 120 may receive, a PHR configuration that indicates one or more PHR parameters associated with one or more events or conditions that trigger a PHR transmission from the UE 120. For example, the PHR configuration may be provided in an RRC message (e.g., PHR-Config) or another suitable signaling message, and may configure PHR parameters such as a PHR periodic timer (e.g., phr-PeriodicTimer), a PHR prohibit timer (e.g., phr-ProhibitTimer), and/or a threshold related to a change to a transmission power factor (e.g., phr-Tx-PowerFactorChange). The PHR periodic timer and the PHR prohibit timer may have respective values that are indicated according to a number of subframes or other time periods. For example, the PHR periodic timer may have a value such as 10, 20, 50, 100, 200, 500, 1000 subframes, or may be configured as an infinite number of subframes (e.g., essentially disabling periodic PHR transmission), and the PHR prohibit timer may have a value such as 10, 20, 50, 100, 200, 500, or 1000 subframes, or may be configured as zero subframes (e.g., such that there is no prohibition on transmitting a PHR that would otherwise be conditioned on the PHR prohibit timer expiring). Furthermore, the threshold may be configured according to a number of decibels (dB), such as 1, 3, or 6 dB, or an infinite number of dBs (e.g., essentially disabling PHR triggers that are conditioned on the threshold related to the transmit power factor change).

Accordingly, as shown by reference number 510, the UE 120 transmits a PHR at a time to based on one or more events or conditions that trigger the PHR transmission. For example, as described herein, the PHR may be triggered when the PHR periodic timer expires, or when a change to a transmit power factor satisfies (e.g., equals or exceeds) the configured threshold and the PHR prohibit expires or has expired. For example, the PHR may be triggered based on the PHR prohibit timer expiring and a change to a path loss for an activated serving cell satisfying the configured threshold. Additionally, or alternatively, the PHR may be triggered based on the PHR prohibit timer expiring and a change to a required power backoff due to power management (e.g., based on a power management maximum power reduction (P-MPR)) satisfying the configured threshold when there are uplink resources allocated for a PUSCH or PUCCH transmission. Additionally, or alternatively, the PHR may be triggered when other suitable events occur, such as a configuration or reconfiguration associated with PHR functionality, activating a secondary cell (SCell) with an uplink configuration, or a primary secondary cell (PSCell) being newly configured or changed.

As described herein, when a PHR is transmitted (e.g., at time to), the PHR indicates how much remaining transmission power is available for the UE 120 to use in addition to an estimated power for one or more current transmissions. For example, to calculate the power headroom, the UE 120 may subtract a power level associated with one or more PUSCH transmissions from a (nominal) maximum transmission power for the UE 120 (e.g., PCMAX). When the PHR indicates a positive power headroom value (measured in dB), the UE 120 has available space (headroom) under the maximum transmission power (e.g., can transmit more uplink data or transmit using a higher transmit power). On the other hand, when the PHR indicates a negative power headroom value, the UE 120 may already be transmitting at a power level that exceeds the maximum transmission power. In this way, the network node 110 can use the information carried in the PHR to make decisions related to resource allocation and power control to maintain balance and avoid interference issues within the wireless network (e.g., depending on whether the UE 120 has a sufficient power margin to increase transmission power or has exceeded a power budget and needs to decrease transmission power to mitigate interference or satisfy emission requirements).

Accordingly, as shown in FIG. 5, the UE 120 may start the PHR prohibit timer and the PHR periodic timer at time to, when the PHR is transmitted to the network node 110, and the UE 120 may be prohibited from transmitting a subsequent PHR that would otherwise be triggered based on a change to the path loss, power backoff, or other transmit power factor satisfying the configured threshold until the PHR prohibit timer expires at time t1. As shown by reference number 512, after the PHR prohibit timer expires at time t1, a PHR may be triggered based on a change to the path loss, power backoff, or other transmit power factor satisfying the configured threshold (e.g., the transmit power factor change triggering the PHR may occur before or after the PHR prohibit timer expires, but the PHR cannot be transmitted until the PHR prohibit timer expires). Furthermore, as shown by reference number 514, after the PHR periodic timer expires at time t2, a PHR may be triggered regardless of any change to a path loss, power backoff, or other parameters related to PHR triggering events or conditions.

As described herein, the conditions, triggering events, periodic timer value, prohibit timer value, or other parameters in a PHR configuration are generally designed for UEs that operate in a half-duplex mode (e.g., only transmitting on an uplink or receiving on a downlink at any given time) in unpaired spectrum such as a TDD band, or in paired spectrum or a FDD band where uplink and downlink frequencies have a sufficient separation to prevent interference between simultaneous downlink and uplink communication. For example, the PHR prohibit timer has a value configured to avoid frequent PHR triggers that may be caused by path loss variations or conditions that may increase or decrease the power backoff associated with power management. Furthermore, the PHR periodic timer may be configured to ensure that the network node 110 has current information about the power headroom at the UE 120, even if the path loss or power backoff at the UE 120 does not change or is stable within a narrow range.

However, a UE 120 may support a full-duplexing mode in unpaired spectrum (also referred to herein as unpaired spectrum full-duplex mode), such as the SBFD mode or the IBFD mode described in further detail elsewhere herein, and may operate in the SBFD or IBFD mode opportunistically, depending on dynamic conditions. For example, operation in the SBFD or IBFD mode may be conditioned on uplink transmission not causing self-interference with downlink reception, which may occur when there is insufficient separation between uplink and downlink beams, when a transmitted signal leaks into a receive port, or due to clutter effects or clutter echo when an object in a surrounding environment reflects a transmitted signal back to a receive port. The self-interference can result in desense, also known as receiver blocking or antenna desensitization, where a radio receiver experiences reduced sensitivity or blockage due to a strong signal on a nearby or overlapping frequency. Among other factors, changes in clutter (e.g., the environment surrounding a UE 120), can result in changes to a residual self-interference and therefore the desense level at the UE 120. As shown by example 520, the residual interference at an SBFD-capable or IBFD-capable UE 120 is determined according to a transmit power and a self-interference mitigation (or cancellation) efficiency at the UE 120, denoted α_{SI}. For example, the residual self-interference per resource block is determined according to the equation

$${I}_{SI}^{per - RB} = \frac{{P}_{tx}^{per - RB}}{{α}_{SI}} , where {P}_{tx}^{per - RB}$$

is the transmission power that the UE 120 applies per resource block. The impact that the residual self-interference has on the duplexing mode depends on the overall desense, which in turn depends an inter-cell interference level compared to a residual self-interference and a maximum desense that the UE 120 has a capability to tolerate in the full-duplexing mode.

Accordingly, the UE 120 may dynamically switch between a full-duplexing mode and a half-duplexing mode due to variations in the self-interference or inter-cell interference. For example, as shown by reference number 522, the UE 120 may maintain a maximum transmission power and operate in (or switch to) a full-duplexing mode when the residual self-interference level is much lower than a co-channel interference (CCI) power. Alternatively, as shown by reference number 524, the UE 120 may maintain the maximum transmission power and operate in (or switch to) a half-duplexing mode when the residual self-interference exceeds the CCI power. Alternatively, the UE 120 may reduce a maximum transmission power or tolerate higher desense to continue full-duplex operation despite variations in the self-interference level or inter-cell interference level. In another example 530, the CCI plus self-interference experienced by a UE 120 is depicted by curve 532, and curve 534 depicts only the CCI that the UE 120 experiences. Above a level 536 where the interference level is substantially equal to the CCI power because self-interference is much less than the CCI, desense is mostly limited by inter-cell interference, while desense is mostly limited by self-interference below the level 536.

Accordingly, one challenge that arises for a UE 120 with SBFD or IBFD capabilities is that the desense is highly dynamic, as the clutter (e.g., reflections or echoes) impacting self-interference depends on an orientation or a mobility of the UE 120, among other examples. Furthermore, the clutter reflections may be small or large, depending on the proximity between the UE 120 and other nearby reflectors as well as the transmission power and directionality. As a result, the UE 120 may apply a backoff to the transmission power to reduce the clutter impact and continue to operate in the full-duplexing mode, switch to a half-duplexing mode, or continue to operate in the full-duplexing mode despite the higher desense. Additionally, or alternatively, the inter-cell interference can vary depending on the orientation or the mobility of the UE 120, and the presence or configurations associated with transmitters in neighboring cells. Accordingly, whether the UE 120 can operate in the SBFD or IBFD mode and the configuration that the UE 120 applies in order to operate in the SBFD or IBFD mode, depends on several factors, including an uplink transmission configuration (e.g., a transmit power, uplink beam, or uplink resource allocation), a downlink transmission configuration (e.g., a frequency gap, downlink beam, or rank), environmental effects (e.g., clutter echo or inter-cell interference), and interference cancellation capabilities. The transmission power available at a UE 120 with SBFD or IBFD capabilities is therefore more dynamic and related to different variables relative to a UE operating in a legacy half-duplex or FDD mode. However, as described above, the parameters and conditions that define PHR trigger events do not account for the dynamic conditions that impact SBFD and IBFD operation, such as changes to self-interference, inter-cell interference, desense, maximum transmission power, or interference cancellation.

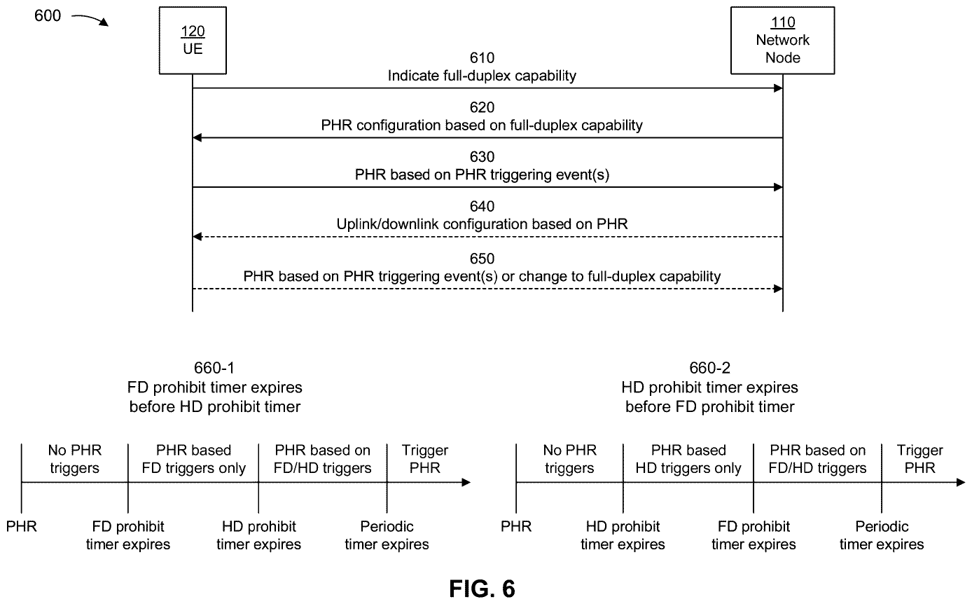

FIG. 6 is a diagram illustrating examples 600 associated with a PHR configuration for a UE 120 with full-duplex capabilities. As shown in FIG. 6, examples 600 include communication between a UE 120 and a network node 110 in a wireless network (e.g., wireless communication network 100). In some aspects, the UE 120 and the network node 110 may communicate via an access link, which includes an uplink and a downlink. In addition, as described herein, the UE 120 may have a full-duplex capability, such as a capability to operate in an unpaired spectrum full-duplex mode (also referred to in the following as ‘full-duplex mode’ for brevity), such as an SBFD mode or an IBFD mode.

As shown by reference number 610, the UE 120 may optionally transmit, and the network node 110 may optionally receive, information that indicates the full-duplex capability associated with the UE 120 (e.g., via RRC signaling, UE capability signaling, or the like). For example, in some aspects, the information indicating the full-duplex capability may indicate that the UE 120 supports the SBFD mode, the IBFD mode, or another suitable full-duplexing mode. In some aspects, the full-duplex capability information may additionally indicate one or more parameters related to operation in the full-duplex mode. For example, in some aspects, the parameters related to the operation in the full-duplex mode may include a self-interference cancellation capability (α_{SI}), antenna or beam configurations that support the full-duplex mode (e.g., beams associated with different antenna panels), a maximum desense that the UE 120 can tolerate in the full-duplex mode, or any other suitable that may impact whether the UE 120 operate in the full-duplex mode or uplink or downlink configurations that the UE 120 can use in the full-duplex mode.

As shown by reference number 620, the network node 110 may transmit, and the UE 120 may receive, a PHR configuration that indicates one or more PHR parameters associated with the full-duplex capability associated with the UE 120. In the description provided herein, whenever reference is made to a PHR parameter associated with the full-duplex capability or a full-duplex mode, a common PHR parameter may be indicated for the full-duplex mode (e.g., for both SBFD and IBFD modes). Additionally, or alternatively, dedicated PHR parameters may be indicated for the SBFD and/or IBFD (and optionally, other full-duplex) modes. For the sake of brevity, reference is made to “the full-duplex mode.” For example, in some aspects, the PHR configuration may indicate a PHR prohibit timer value for operation in the full-duplex mode. In some aspects, the PHR prohibit timer value for operation in the full-duplex mode may be indicated in addition to a legacy PHR prohibit timer (e.g., phr-ProhibitTimer) for operation in a half-duplexing mode or a legacy FDD mode (e.g., FDD mode in paired spectrum) in which self-interference or inter-cell interference has less variation or impact relative to operation in the full-duplex mode. In some aspects, the UE 120 may transmit information to the network node 110 to indicate a recommended or preferred value for the PHR prohibit timer value associated with operation in the full-duplex mode. For example, in some aspects, the recommended or preferred value for the PHR prohibit timer may be based on internal knowledge that the UE 120 has related to how often the capability to operate in the full-duplex mode changes (e.g., based on historical information related to operation in in the full-duplex mode) or predictions related to changes to the capability to operate in the full-duplex mode (e.g., based on rules or AI/ML models associated with mobility patterns, traffic patterns, or the like). In some aspects, the recommended or preferred value for the PHR prohibit timer may be indicated in the message that indicates the full-duplexing capability associated with the UE 120 or a separate message.

In some aspects, the PHR configuration may additionally indicate one or more thresholds related to PHR trigger events or conditions based on parameters that impact operation in the full-duplex mode. For example, the one or more thresholds may relate to a change to a self-interference level, an inter-cell interference level, a desense level, a self-interference mitigation or cancellation efficiency, or a maximum transmission power. In some aspects, the PHR configuration may indicate a respective (e.g., separate) threshold for the change to self-interference, inter-cell interference level, desense, self-interference mitigation or cancellation, and/or maximum transmission power. Additionally, or alternatively, the PHR configuration may indicate one or more thresholds that are shared for one or more parameters (e.g., the self-interference level and the inter-cell interference level may share a threshold, such that a PHR trigger event may occur if a change to at least one of the self-interference level or the inter-cell interference level satisfies the shared threshold). In some aspects, the PHR configuration may indicate the one or more thresholds associated with changes to full-duplex conditions in addition to a legacy threshold (e.g., phr-Tx-PowerFactorChange) associated with a change to a path loss or power backoff. In addition, the PHR configuration may indicate a PHR periodic timer that applies to operation in the full-duplex mode and the legacy half-duplex or FDD mode, or may indicate a first PHR periodic timer that applies to operation in the full-duplex mode and a second PHR periodic timer that applies to the legacy half-duplex or FDD mode.

As shown by reference number 630, the UE 120 may transmit, and the network node 110 may receive, a PHR based on one or more PHR triggering events while operating in the full-duplex mode. For example, as described herein, a PHR is generally triggered upon configuration or reconfiguration of PHR functionality, whereby the PHR transmitted by the UE 120 may be triggered by the PHR configuration provided by the network node 110. In some aspects, as described herein, the UE 120 may start a PHR periodic timer upon transmitting the PHR (e.g., a PHR periodic timer that is shared between different full-duplex modes and legacy modes or a PHR periodic timer dedicated to the full-duplex mode in which the UE 120 is operating). In addition, upon transmitting the PHR, the UE 120 may start the PHR prohibit timer associated with full-duplex operation, and optionally also start the legacy PHR prohibit timer associated with half-duplex or FDD operation. As described herein, the PHR may generally indicate the extent to which the UE 120 is over or under a power budget based on a maximum transmission power at the UE 120 and a current transmission power.

As shown by reference number 640, the network node 110 may transmit, and the UE 120 may receive, an uplink or downlink configuration based on the PHR transmitted by the UE 120. For example, depending on whether the UE 120 is over or under the power budget associated with the maximum transmission power, the network node 110 may configure an uplink power, an uplink beam, an uplink resource allocation (e.g., scheduling a PUSCH with a relatively larger or smaller number of resource blocks, or at different transmission time intervals), a downlink beam, a frequency gap, a rank, or any other suitable uplink or downlink parameters. For example, the network node 110 may configure uplink or downlink parameters to mitigate self-interference or to increase uplink or downlink performance. Additionally, or alternatively, the network node 110 may configure uplink or downlink parameters for other UEs in the cell in accordance with the power headroom at the UE 120 (e.g., to mitigate cross-link interference at the UE 120 or to increase performance at the UE 120 or cell-wide). Accordingly, in some aspects, the UE 120 may optionally transmit one or more messages (e.g., a PUSCH) to the network node 110 (not specifically shown in FIG. 6) using a transmit power that is based on the power headroom in accordance with scheduling information in the uplink or downlink configuration.

As shown by reference number 650, the UE 120 may transmit a (subsequent) PHR based on one or more PHR triggering events or a change to the full-duplex capability associated with the UE 120. For example, as described above, the UE 120 may start a PHR periodic timer upon transmitting a PHR, and may also the UE 120 may start the PHR prohibit timer associated with full-duplex operation and the legacy PHR prohibit timer associated with half-duplex or FDD operation upon transmitting the PHR. Accordingly, timing associated with one or more PHR triggering events may depend on an interaction between the PHR prohibit timer associated with full-duplex operation and the legacy PHR prohibit timer.

The values of the PHR prohibit timer associated with full-duplex operation and of the legacy PHR prohibit timer may be the same or may be different. For example, reference number 660-1 depicts a scenario associated with a PHR configuration in which the PHR prohibit timer associated with full-duplex operation is shorter than the legacy PHR prohibit timer, such that the PHR prohibit timer associated with full-duplex operation expires before the legacy PHR prohibit timer. In the scenario depicted by reference number 660-1, after transmitting the PHR and before the PHR prohibit timer associated with full-duplex operation has expired, no PHR triggering events occur regardless of any change or variations in self-interference, inter-cell interference, desense, maximum transmission power, interference cancellation efficiency, or the like. In other words, while the PHR prohibit timer associated with full-duplex operation is running, no PHR is triggered. Similarly, because the PHR prohibit timer associated with full-duplex operation is shorter than the legacy PHR prohibit timer, no PHR triggering events occur regardless of any change or variations in a path loss or power backoff. After the PHR prohibit timer associated with full-duplex operation has expired and before the legacy PHR prohibit timer has expired, a PHR may be triggered based on full-duplex triggers only. For example, in the time period after the PHR prohibit timer associated with full-duplex operation has expired and before the legacy PHR prohibit timer has expired, a PHR may be triggered based on a change to self-interference, inter-cell interference, desense, maximum transmission power, interference cancellation efficiency, or the like satisfying the configured threshold(s). After the legacy PHR prohibit timer has expired, a PHR may be triggered based on full-duplex triggers or legacy triggers (e.g., the PHR triggers may include a path loss change or a power backoff changing satisfying the configured threshold, and the full-duplex triggers described herein). After the periodic timer expires, a PHR is triggered, even if none of the threshold-based conditions are satisfied.

Alternatively, reference number 660-2 depicts a scenario associated with a PHR configuration in which the PHR prohibit timer associated with full-duplex operation is longer than the legacy PHR prohibit timer, such that the legacy PHR prohibit timer expires before the PHR prohibit timer associated with full-duplex operation. In the scenario depicted by reference number 660-2, after transmitting the PHR and before the legacy PHR prohibit timer has expired, no PHR triggering events occur regardless of any change or variations in self-interference, inter-cell interference, desense, maximum transmission power, interference cancellation efficiency, path loss, or power backoff (e.g., regardless of any changes related to full-duplex and/or half-duplex operation, also referred to as full-duplex PHR triggers and/or legacy/half-duplex PHR triggers). After the legacy PHR prohibit timer has expired and before the PHR prohibit timer associated with full-duplex operation has expired, a PHR may be triggered based on legacy PHR triggers only. For example, in the time period after the legacy PHR prohibit timer has expired and before the PHR prohibit timer associated with full-duplex operation has expired, a PHR may be triggered based on a change to a path loss or a power backoff satisfying the configured threshold. After the PHR prohibit timer associated with full-duplex operation has expired, a PHR may be triggered based on full-duplex triggers or legacy triggers (e.g., the PHR triggers may include a path loss change or a power backoff changing satisfying the configured threshold, and the full-duplex triggers described herein). After the periodic timer expires, a PHR is triggered, even if none of the threshold-based conditions are satisfied.

Alternatively, in a scenario (not shown in FIG. 6) where the PHR prohibit timer associated with full-duplex operation and the legacy PHR prohibit timer have the same value, no PHR triggering events occur after transmitting the PHR until the shared PHR prohibit timer expires, a PHR may be triggered based on full-duplex triggers or legacy triggers after the shared PHR prohibit timer expires and before the PHR periodic timer expires, and a PHR is triggered after the periodic timer expires even if none of the threshold-based PHR triggers are satisfied.

Additionally, or alternatively, the PHR trigger(s) may relate to a change to the duplexing capability associated with the UE 120. More specifically, the PHR trigger(s) may relate to a change to the temporary ability (or capability) of the UE 120 to maintain or continue full-duplex, such as SBFD or IBFD, operation wherein the change may be related to external factors such as the above-described interferences and/or internal factors such as changes in nominal transmit power, a power backoff, or internal power management of the UE 120. For example, as described elsewhere herein, full-duplex capabilities are highly dynamic, dependent on variations in self-interference, inter-cell interference, clutter effects, or the like. Accordingly, in cases where a change to desense, self-interference, inter-cell interference, clutter effects, interference cancellation capabilities, or the like resulting in the UE 120 being unable to the communicate in the full-duplex mode (e.g., because of an unacceptably high bit-error rate (BER)), the UE may transmit the PHR to the network node 110 to indicate the inability to communicate in the full-duplex mode or a need to switch to a legacy half-duplexing or FDD mode. For example, in some aspects, the PHR may include a special value (e.g., a particular value or range for the maximum transmission power at the UE 120 or another indicator) used to indicate that the UE 120 is unable to communicate in the full-duplex mode. Alternatively, in some aspects, a PHR is not triggered when the UE 120 loses the capability to communicate in the full-duplex mode, and the inability to communicate in the full-duplex mode may be indicated to the network node 110 in another message (e.g., in UCI or a PUCCH, an uplink MAC-CE, or the like).

In some aspects, in cases where the UE 120 regains the capability to communicate in the full-duplex mode, a PHR may be triggered immediately to indicate that the UE 120 is able to communicate in the full-duplex mode (e.g., similar to a PHR that is immediately triggered when a new SCell with an uplink configuration is activated). Alternatively, the PHR may be triggered after a timer expires, where the timer may have a value that is specific to reporting a change to the full-duplex duplexing capability. For example, in some aspects, the PHR may be triggered after the timer expires, rather than immediately, in case there are frequent changes to self-interference, inter-cell interference, clutter effects, or other conditions that may impact the full-duplex capability (e.g., to ensure that the regained full-duplex capability is stable, and to avoid triggering a PHR to indicate that the UE 120 has regained the full-duplex capability when the PHR is followed by the UE 120 losing the full-duplex capability within a short time period thereafter).

FIG. 7 is a diagram illustrating an example process 700 performed, for example, at a UE or an apparatus of a UE. Example process 700 is an example where the apparatus or the UE (e.g., UE 120) performs operations associated with a PHR configuration for a UE with full-duplex capabilities.

As shown in FIG. 7, in some aspects, process 700 may include receiving, from a network node, a PHR configuration indicating one or more PHR parameters for operation in a full-duplex mode in unpaired spectrum (block 710). For example, the UE (e.g., using reception component 902 or communication manager 906, depicted in FIG. 9) may receive, from a network node, a PHR configuration indicating one or more PHR parameters for operation in a full-duplex mode in unpaired spectrum, as described above.

As further shown in FIG. 7, in some aspects, process 700 may include transmitting, to the network node, a PHR in accordance with the PHR configuration (block 720). For example, the UE (e.g., using transmission component 904 or communication manager 906, depicted in FIG. 9) may transmit, to the network node, a PHR in accordance with the PHR configuration, as described above.

Process 700 may include additional aspects, such as any single aspect or any combination of aspects described below or in connection with one or more other processes described elsewhere herein.

In a first aspect, the one or more PHR parameters include a value for a PHR prohibit timer for operation in the full-duplex mode.

In a second aspect, alone or in combination with the first aspect, process 700 includes starting the PHR prohibit timer for operation in the full-duplex mode when the PHR is transmitted, wherein transmitting a subsequent PHR is prohibited until the PHR prohibit timer for operation in the full-duplex mode has expired.

In a third aspect, alone or in combination with one or more of the first and second aspects, the one or more PHR parameters include a threshold associated with a change to a communication parameter that impacts operation in the full-duplex mode.

In a fourth aspect, alone or in combination with one or more of the first through third aspects, process 700 includes transmitting, to the network node, a subsequent PHR in accordance with the change to the communication parameter satisfying the threshold, wherein the subsequent PHR is transmitted after the PHR prohibit timer for operation in the full-duplex mode has expired.

In a fifth aspect, alone or in combination with one or more of the first through fourth aspects, the communication parameter includes at least one of a self-interference level, an inter-cell interference level, a desense level, a maximum transmission power, or an interference cancellation efficiency.

In a sixth aspect, alone or in combination with one or more of the first through fifth aspects, process 700 includes transmitting, to the network node, a recommended value for the PHR prohibit timer for operation in the full-duplex mode.

In a seventh aspect, alone or in combination with one or more of the first through sixth aspects, the value for the PHR prohibit timer for operation in the full-duplex mode is associated with the recommended value for the PHR prohibit for operation in the full-duplex mode.

In an eighth aspect, alone or in combination with one or more of the first through seventh aspects, the one or more PHR parameters further include a value for a PHR prohibit timer for operation in a half-duplex mode.

In a ninth aspect, alone or in combination with one or more of the first through eighth aspects, process 700 includes starting the PHR prohibit timer for operation in the full-duplex mode and the PHR prohibit timer for operation in the half-duplex mode when the PHR is transmitted, wherein the value for the PHR prohibit timer for operation in the full-duplex mode is shorter than the value for the PHR prohibit timer for operation in the half-duplex mode, and transmitting, to the network node after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

In a tenth aspect, alone or in combination with one or more of the first through ninth aspects, process 700 includes starting the PHR prohibit timer for operation in the full-duplex mode and the PHR prohibit timer for operation in the half-duplex mode when the PHR is transmitted, wherein the value for the PHR prohibit timer for operation in the full-duplex mode is longer than the value for the PHR prohibit timer for operation in the half-duplex mode, and transmitting, to the network node after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

In an eleventh aspect, alone or in combination with one or more of the first through tenth aspects, process 700 includes transmitting, to the network node, an indication that the UE is unable to operate in the full-duplex mode in accordance with one or more communication parameters that impact operation in the full-duplex mode.

In a twelfth aspect, alone or in combination with one or more of the first through eleventh aspects, the indication that the UE is unable to operate in the full-duplex mode is included in a PHR.

In a thirteenth aspect, alone or in combination with one or more of the first through twelfth aspects, process 700 includes transmitting, to the network node, a PHR indicating that the UE is able to operate in the full-duplex mode in accordance with a change to the one or more communication parameters that impact operation in the full-duplex mode.

In a fourteenth aspect, alone or in combination with one or more of the first through thirteenth aspects, the PHR is transmitted after a timer related to a change to a capability to operate in the full-duplex mode.

In a fifteenth aspect, alone or in combination with one or more of the first through fourteenth aspects, process 700 includes receiving, from the network node, scheduling information associated with the PHR and indicating one or more parameters for an uplink message.

In a sixteenth aspect, alone or in combination with one or more of the first through fifteenth aspects, process 700 includes transmitting, to the network node, the uplink message in accordance with the scheduling information associated with the PHR.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with a PHR configuration for a UE with full-duplex capabilities.

As shown in FIG. 8, in some aspects, process 800 may include transmitting, to a UE, a PHR configuration indicating one or more PHR parameters for operation in a full-duplex mode in unpaired spectrum (block 810). For example, the network node (e.g., using transmission component 1004 or communication manager 1006, depicted in FIG. 10) may transmit, to a UE, a PHR configuration indicating one or more PHR parameters for operation in a full-duplex mode in unpaired spectrum, as described above.

As further shown in FIG. 8, in some aspects, process 800 may include receiving, from the UE, a PHR in accordance with the PHR configuration (block 820). For example, the network node (e.g., using reception component 1002 or communication manager 1006, depicted in FIG. 10) may receive, from the UE, a PHR in accordance with the PHR configuration, as described above.

Process 800 may include additional aspects, such as any single aspect or any combination of aspects described below or in connection with one or more other processes described elsewhere herein.

In a first aspect, the one or more PHR parameters include a value for a PHR prohibit timer for operation in the full-duplex mode.

In a second aspect, alone or in combination with the first aspect, the UE is prohibited from transmitting a subsequent PHR until the PHR prohibit timer for operation in the full-duplex mode has expired.

In a third aspect, alone or in combination with one or more of the first and second aspects, the one or more PHR parameters include a threshold associated with a change to a communication parameter that impacts operation in the full-duplex mode.

In a fourth aspect, alone or in combination with one or more of the first through third aspects, process 800 includes receiving, from the UE after the PHR prohibit for operation in the full-duplex mode timer has expired, a subsequent PHR in accordance with the change to the communication parameter satisfying the threshold.

In a fifth aspect, alone or in combination with one or more of the first through fourth aspects, the communication parameter includes at least one of a self-interference level, an inter-cell interference level, a desense level, a maximum transmission power, or an interference cancellation efficiency.

In a sixth aspect, alone or in combination with one or more of the first through fifth aspects, process 800 includes receiving, from the UE, a recommended value for the PHR prohibit timer for operation in the full-duplex mode.

In a seventh aspect, alone or in combination with one or more of the first through sixth aspects, the value for the PHR prohibit timer for operation in the full-duplex mode is associated with the recommended value for the PHR prohibit for operation in the full-duplex mode.

In an eighth aspect, alone or in combination with one or more of the first through seventh aspects, the one or more PHR parameters further include a value for a PHR prohibit timer for operation in a half-duplex mode.

In a ninth aspect, alone or in combination with one or more of the first through eighth aspects, the value for the PHR prohibit timer for operation in the full-duplex mode is shorter than the value for the PHR prohibit timer for operation in the half-duplex mode, and wherein the method further comprises receiving, from the UE after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

In a tenth aspect, alone or in combination with one or more of the first through ninth aspects, the value for the PHR prohibit timer for operation in the full-duplex mode is longer than the value for the PHR prohibit timer for operation in the half-duplex mode, and wherein the method further comprises receiving, from the UE after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

In an eleventh aspect, alone or in combination with one or more of the first through tenth aspects, process 800 includes receiving, from the UE, an indication that the UE is unable to operate in the full-duplex mode in accordance with one or more communication parameters that impact operation in the full-duplex mode.

In a twelfth aspect, alone or in combination with one or more of the first through eleventh aspects, the indication that the UE is unable to operate in the full-duplex mode is included in a PHR.

In a thirteenth aspect, alone or in combination with one or more of the first through twelfth aspects, process 800 includes receiving, from the UE, a PHR indicating that the UE is able to operate in the full-duplex mode in accordance with a change to the one or more communication parameters that impact operation in the full-duplex mode.

In a fourteenth aspect, alone or in combination with one or more of the first through thirteenth aspects, the PHR is received after a timer related to a change to a capability to operate in the full-duplex mode.

In a fifteenth aspect, alone or in combination with one or more of the first through fourteenth aspects, process 800 includes transmitting, to the UE, scheduling information associated with the PHR and indicating one or more parameters for an uplink message.

In a sixteenth aspect, alone or in combination with one or more of the first through fifteenth aspects, process 800 includes receiving, from the UE, the uplink message in accordance with the scheduling information associated with the PHR.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE 120, or a UE 120 may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE 120.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE 120 described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE 120 described above in connection with FIG. 1, such as a radio, one or more RF chains, one or more transceivers, or one or more modems, each of which may in turn be coupled with one or more antennas of the UE 120.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive, from a network node, a PHR configuration indicating one or more PHR parameters for operation in a full-duplex mode in unpaired spectrum. The transmission component 904 may transmit, to the network node, a PHR in accordance with the PHR configuration.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node 110, or a network node 110 may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node 110.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node 110 described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node 110 described above in connection with FIG. 1, such as a radio, one or more RF chains, one or more transceivers, or one or more modems, each of which may in turn be coupled with one or more antennas of the network node 110. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a UE, a PHR configuration indicating one or more PHR parameters for operation in a full-duplex mode in unpaired spectrum. The reception component 1002 may receive, from the UE, a PHR in accordance with the PHR configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving, from a network node, a PHR configuration indicating one or more PHR parameters for operation in a full-duplex mode in unpaired spectrum; and transmitting, to the network node, a PHR in accordance with the PHR configuration.

Aspect 2: The method of Aspect 1, wherein the one or more PHR parameters include a value for a PHR prohibit timer for operation in the full-duplex mode.

Aspect 3: The method of Aspect 2, further comprising: starting the PHR prohibit timer for operation in the full-duplex mode when the PHR is transmitted, wherein transmitting a subsequent PHR is prohibited until the PHR prohibit timer for operation in the full-duplex mode has expired.

Aspect 4: The method of Aspect 2, wherein the one or more PHR parameters include a threshold associated with a change to a communication parameter that impacts operation in the full-duplex mode.

Aspect 5: The method of Aspect 4, further comprising: transmitting, to the network node, a subsequent PHR in accordance with the change to the communication parameter satisfying the threshold, wherein the subsequent PHR is transmitted after the PHR prohibit timer for operation in the full-duplex mode has expired.

Aspect 6: The method of Aspect 4, wherein the communication parameter includes at least one of a self-interference level, an inter-cell interference level, a desense level, a maximum transmission power, or an interference cancellation efficiency.

Aspect 7: The method of Aspect 2, further comprising: transmitting, to the network node, a recommended value for the PHR prohibit timer for operation in the full-duplex mode.

Aspect 8: The method of Aspect 7, wherein the value for the PHR prohibit timer for operation in the full-duplex mode is associated with the recommended value for the PHR prohibit for operation in the full-duplex mode.

Aspect 9: The method of Aspect 2, wherein the one or more PHR parameters further include a value for a PHR prohibit timer for operation in a half-duplex mode.

Aspect 10: The method of Aspect 8, further comprising: starting the PHR prohibit timer for operation in the full-duplex mode and the PHR prohibit timer for operation in the half-duplex mode when the PHR is transmitted, wherein the value for the PHR prohibit timer for operation in the full-duplex mode is shorter than the value for the PHR prohibit timer for operation in the half-duplex mode; and transmitting, to the network node after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

Aspect 11: The method of Aspect 8, further comprising: starting the PHR prohibit timer for operation in the full-duplex mode and the PHR prohibit timer for operation in the half-duplex mode when the PHR is transmitted, wherein the value for the PHR prohibit timer for operation in the full-duplex mode is longer than the value for the PHR prohibit timer for operation in the half-duplex mode; and transmitting, to the network node after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

Aspect 12: The method of any of Aspects 1-11, further comprising: transmitting, to the network node, an indication that the UE is unable to operate in the full-duplex mode in accordance with one or more communication parameters that impact operation in the full-duplex mode.

Aspect 13: The method of Aspect 11, wherein the indication that the UE is unable to operate in the full-duplex mode is included in a PHR.

Aspect 14: The method of Aspect 11, further comprising: transmitting, to the network node, a PHR indicating that the UE is able to operate in the full-duplex mode in accordance with a change to the one or more communication parameters that impact operation in the full-duplex mode.

Aspect 15: The method of Aspect 13, wherein the PHR is transmitted after a timer related to a change to a capability to operate in the full-duplex mode.

Aspect 16: The method of any of Aspects 1-15, further comprising: receiving, from the network node, scheduling information associated with the PHR and indicating one or more parameters for an uplink message.

Aspect 17: The method of Aspect 15, further comprising: transmitting, to the network node, the uplink message in accordance with the scheduling information associated with the PHR.

Aspect 18: A method of wireless communication performed by a network node, comprising: transmitting, to a UE, a PHR configuration indicating one or more PHR parameters for operation in a full-duplex mode in unpaired spectrum; and receiving, from the UE, a PHR in accordance with the PHR configuration.

Aspect 19: The method of Aspect 18, wherein the one or more PHR parameters include a value for a PHR prohibit timer for operation in the full-duplex mode.

Aspect 20: The method of Aspect 19, wherein the UE is prohibited from transmitting a subsequent PHR until the PHR prohibit timer for operation in the full-duplex mode has expired.

Aspect 21: The method of Aspect 19, wherein the one or more PHR parameters include a threshold associated with a change to a communication parameter that impacts operation in the full-duplex mode.

Aspect 22: The method of Aspect 21, further comprising: receiving, from the UE after the PHR prohibit for operation in the full-duplex mode timer has expired, a subsequent PHR in accordance with the change to the communication parameter satisfying the threshold.

Aspect 23: The method of Aspect 21, wherein the communication parameter includes at least one of a self-interference level, an inter-cell interference level, a desense level, a maximum transmission power, or an interference cancellation efficiency.

Aspect 24: The method of Aspect 19, further comprising: receiving, from the UE, a recommended value for the PHR prohibit timer for operation in the full-duplex mode.

Aspect 25: The method of Aspect 24, wherein the value for the PHR prohibit timer for operation in the full-duplex mode is associated with the recommended value for the PHR prohibit for operation in the full-duplex mode.

Aspect 26: The method of Aspect 19, wherein the one or more PHR parameters further include a value for a PHR prohibit timer for operation in a half-duplex mode.

Aspect 27: The method of Aspect 26, wherein the value for the PHR prohibit timer for operation in the full-duplex mode is shorter than the value for the PHR prohibit timer for operation in the half-duplex mode, and wherein the method further comprises: receiving, from the UE after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

Aspect 28: The method of Aspect 26, wherein the value for the PHR prohibit timer for operation in the full-duplex mode is longer than the value for the PHR prohibit timer for operation in the half-duplex mode, and wherein the method further comprises: receiving, from the UE after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

Aspect 29: The method of any of Aspects 18-28, further comprising: receiving, from the UE, an indication that the UE is unable to operate in the full-duplex mode in accordance with one or more communication parameters that impact operation in the full-duplex mode.

Aspect 30: The method of Aspect 29, wherein the indication that the UE is unable to operate in the full-duplex mode is included in a PHR.

Aspect 31: The method of Aspect 29, further comprising: receiving, from the UE, a PHR indicating that the UE is able to operate in the full-duplex mode in accordance with a change to the one or more communication parameters that impact operation in the full-duplex mode.

Aspect 32: The method of Aspect 31, wherein the PHR is received after a timer related to a change to a capability to operate in the full-duplex mode.

Aspect 33: The method of any of Aspects 18-32, further comprising: transmitting, to the UE, scheduling information associated with the PHR and indicating one or more parameters for an uplink message.

Aspect 34: The method of Aspect 33, further comprising: receiving, from the UE, the uplink message in accordance with the scheduling information associated with the PHR.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

Aspect 42: A device comprising a processing system that includes one or more processors and one or more code-storing memories coupled with the one or more processors, the processing system configured to cause the device to perform the method of one or more of Aspects 1-34.

Aspect 43: A device comprising a processing system that includes processor circuitry and code-storing memory circuitry, the processing system configured to cause the device to perform the method of one or more of Aspects 1-34.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a power headroom report (PHR) configuration indicating one or more PHR parameters for operation in a full-duplex mode in unpaired spectrum; and
transmit, to the network node, a PHR in accordance with the PHR configuration.

2. The UE of claim 1, wherein the one or more PHR parameters include a value for a PHR prohibit timer for operation in the full-duplex mode.

3. The UE of claim 2, wherein the processing system is further configured to cause the UE to:
start the PHR prohibit timer for operation in the full-duplex mode when the PHR is transmitted, wherein transmitting a subsequent PHR is prohibited until the PHR prohibit timer for operation in the full-duplex mode has expired.

4. The UE of claim 2, wherein the one or more PHR parameters include a threshold associated with a change to a communication parameter that impacts operation in the full-duplex mode.

5. The UE of claim 4, wherein the processing system is further configured to cause the UE to:
transmit, to the network node, a subsequent PHR in accordance with the change to the communication parameter satisfying the threshold, wherein the subsequent PHR is transmitted after the PHR prohibit timer for operation in the full-duplex mode has expired.

6. The UE of claim 4, wherein the communication parameter includes at least one of a self-interference level, an inter-cell interference level, a desense level, a maximum transmission power, or an interference cancellation efficiency.

7. The UE of claim 2, wherein the processing system is further configured to cause the UE to:
transmit, to the network node, a recommended value for the PHR prohibit timer for operation in the full-duplex mode.

8. The UE of claim 7, wherein the value for the PHR prohibit timer for operation in the full-duplex mode is associated with the recommended value for the PHR prohibit for operation in the full-duplex mode.

9. The UE of claim 2, wherein the one or more PHR parameters further include a value for a PHR prohibit timer for operation in a half-duplex mode.

10. The UE of claim 8, wherein the processing system is further configured to cause the UE to:
start the PHR prohibit timer for operation in the full-duplex mode and the PHR prohibit timer for operation in the half-duplex mode when the PHR is transmitted, wherein the value for the PHR prohibit timer for operation in the full-duplex mode is shorter than the value for the PHR prohibit timer for operation in the half-duplex mode; and
transmit, to the network node after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

11. The UE of claim 8, wherein the processing system is further configured to cause the UE to:
start the PHR prohibit timer for operation in the full-duplex mode and the PHR prohibit timer for operation in the half-duplex mode when the PHR is transmitted, wherein the value for the PHR prohibit timer for operation in the full-duplex mode is longer than the value for the PHR prohibit timer for operation in the half-duplex mode; and
transmitting, to the network node after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

12. The UE of claim 1, wherein the processing system is further configured to cause the UE to:
transmit, to the network node, an indication that the UE is unable to operate in the full-duplex mode in accordance with one or more communication parameters that impact operation in the full-duplex mode.

13. The UE of claim 11, wherein the indication that the UE is unable to operate in the full-duplex mode is included in a PHR.

14. The UE of claim 11, wherein the processing system is further configured to cause the UE to:
transmit, to the network node, a PHR indicating that the UE is able to operate in the full-duplex mode in accordance with a change to the one or more communication parameters that impact operation in the full-duplex mode.

15. The UE of claim 13, wherein the PHR is transmitted after a timer related to a change to a capability to operate in the full-duplex mode.

16. The UE of claim 1, wherein the processing system is further configured to cause the UE to:
receive, from the network node, scheduling information associated with the PHR and indicating one or more parameters for an uplink message.

17. The UE of claim 15, wherein the processing system is further configured to cause the UE to:
transmit, to the network node, the uplink message in accordance with the scheduling information associated with the PHR.

18. A network node, comprising:
a processing system that includes one or more processors and one or more code-storing memories coupled with the one or more processors, the processing system configured to cause the network node to:
transmit, to a user equipment (UE), a power headroom report (PHR) configuration indicating one or more PHR parameters for operation in a full-duplex mode in unpaired spectrum; and
receive, from the UE, a PHR in accordance with the PHR configuration.

19. The network node of claim 18, wherein the one or more PHR parameters include a value for a PHR prohibit timer for operation in the full-duplex mode.

20. The network node of claim 19, wherein the UE is prohibited from transmitting a subsequent PHR until the PHR prohibit timer for operation in the full-duplex mode has expired.

21. The network node of claim 19, wherein the one or more PHR parameters include a threshold associated with a change to a communication parameter that impacts operation in the full-duplex mode.

22. The network node of claim 21, wherein the processing system is further configured to cause the network node to:
receive, from the UE after the PHR prohibit for operation in the full-duplex mode timer has expired, a subsequent PHR in accordance with the change to the communication parameter satisfying the threshold.

23. The network node of claim 21, wherein the communication parameter includes at least one of a self-interference level, an inter-cell interference level, a desense level, a maximum transmission power, or an interference cancellation efficiency.

24. The network node of claim 19, wherein the processing system is further configured to cause the network node to:
receive, from the UE, a recommended value for the PHR prohibit timer for operation in the full-duplex mode.

25. The network node of claim 24, wherein the value for the PHR prohibit timer for operation in the full-duplex mode is associated with the recommended value for the PHR prohibit for operation in the full-duplex mode.

26. The network node of claim 19, wherein the one or more PHR parameters further include a value for a PHR prohibit timer for operation in a half-duplex mode.

27. The network node of claim 26, wherein the value for the PHR prohibit timer for operation in the full-duplex mode is shorter than the value for the PHR prohibit timer for operation in the half-duplex mode, and wherein the processing system is further configured to cause the network node to:
receive, from the UE after the PHR prohibit timer for operation in the full-duplex mode has expired and before the PHR prohibit timer for operation in the half-duplex capability has expired, a second PHR in accordance with one or more communication parameters related to operation in the full-duplex mode satisfying a condition.

28. The network node of claim 26, wherein the value for the PHR prohibit timer for operation in the full-duplex mode is longer than the value for the PHR prohibit timer for operation in the half-duplex mode, and wherein the processing system is further configured to cause the network node to:
receive, from the UE after the PHR prohibit timer for operation in the half-duplex mode has expired and before the PHR prohibit timer for operation in the full-duplex mode has expired, a second PHR in accordance with a change to a transmit pathloss or a power backoff satisfying a threshold.

29. The network node of claim 18, wherein the processing system is further configured to cause the network node to:
receive, from the UE, an indication that the UE is unable to operate in the full-duplex mode in accordance with one or more communication parameters that impact operation in the full-duplex mode.

30. The network node of claim 29, wherein the indication that the UE is unable to operate in the full-duplex mode is included in a PHR.

31. The network node of claim 29, wherein the processing system is further configured to cause the network node to:
receive, from the UE, a PHR indicating that the UE is able to operate in the full-duplex mode in accordance with a change to the one or more communication parameters that impact operation in the full-duplex mode.

32. The network node of claim 31, wherein the PHR is received after a timer related to a change to a capability to operate in the full-duplex mode.

33. The network node of claim 18, wherein the processing system is further configured to cause the network node to:
transmit, to the UE, scheduling information associated with the PHR and indicating one or more parameters for an uplink message.

34. The network node of claim 33, wherein the processing system is further configured to cause the network node to:
receive, from the UE, the uplink message in accordance with the scheduling information associated with the PHR.

35. A method of wireless communication performed by a user equipment (UE), comprising:
receiving, from a network node, a power headroom report (PHR) configuration indicating one or more PHR parameters for operation in a full-duplex mode in unpaired spectrum; and
transmitting, to the network node, a PHR in accordance with the PHR configuration.

36. A method of wireless communication performed by a network node, comprising:
transmitting, to a user equipment (UE), a power headroom report (PHR) configuration indicating one or more PHR parameters for operation in a full-duplex mode in unpaired spectrum; and
receiving, from the UE, a PHR in accordance with the PHR configuration.
